(19) United States
(12) Patent Application Publication
(10) Pub. No.: US 2026/0286191 A1
(43) Pub. Date: Sep. 24, 2026

(54) ARTICLE FOR REPAIRING PAINTED SURFACES, AND METHOD FOR MANUFACTURING SUCH AN ARTICLE

(71) Applicant: CORSO MAGENTA, Nanterre (FR)

(72) Inventors: Sébastien ROY, Le Thor (FR); Stanislas CHEVALLIER, Nanterre (FR); Gwendal HUET, Nanterre (FR)

(73) Assignee: CORSO MAGENTA, Nanterre (FR)

(21) Appl. No.: 19/474,430

(22) PCT Filed: Apr. 15, 2024
(86) PCT No.: PCT/IB2024/053671

§ 371 Date: Oct. 10, 2025

(30) Foreign Application Priority Data
Apr. 14, 2023 (FR) FR2303776

(51) Int. Cl. C09J 7/29; B32B 3/30; B32B 7/12; C09J 5/00

(52) U.S. Cl. CPC C09J 7/29; B32B 3/30; B32B 7/12; C09J 5/00; B32B 2405/00; C09J 2301/16

(57) ABSTRACT

An article including a layer of dry paint, a layer of an activatable adhesive adjacent to the layer of dry paint, a protective layer adhering to the layer of dry paint on the side thereof opposite the layer of adhesive, and a protective film attached to the layer of adhesive on the side thereof opposite the layer of dry paint. The adhesive forces between the protective layer and the layer of dry paint are controlled and maintained between the adhesive forces between the protective film and the layer of adhesive before activation thereof, and the adhesive forces between the layer of paint and a final support, via the layer of adhesive after activation thereof. In some embodiments, the article is used for repairing painted surfaces in various industries.

### FIELD OF THE INVENTION

The present invention generally relates to the repair of painted surfaces, in particular surfaces having a quality requirement under technical regulations.

### Prior Art

Traditionally, the repair of painted surfaces is carried out by stripping a minimum area to be repainted, smoothing, and then applying one or more layers of paint in liquid form.

It is understood that these operations are tedious and time-consuming, and expose operators to volatile organic compounds that are hazardous to health. Furthermore, in some areas such as aviation maintenance, certain rules prohibit the simultaneous performance of such operations at the same time as other operations, which adversely lengthens maintenance times.

The present invention aims to propose an article making it much easier to repair damaged paint areas in view of these problems, as well as a particular method for manufacturing such an article.

### SUMMARY OF THE INVENTION

For this purpose, an article is proposed in particular for the repair of painted surfaces, comprising:
a layer of dry paint,
a layer of an activatable adhesive adjacent to the layer of dry paint,
a protective layer adhering to the layer of dry paint on the side thereof opposite the layer of adhesive, and
a protective film attached to the layer of adhesive on the side thereof opposite the layer of dry paint,
   wherein the adhesive forces between the protective layer and the layer of dry paint are controlled and maintained between the adhesive forces between the protective film and the layer of adhesive before activation thereof, and the adhesive forces between the layer of paint and a final support, via the layer of adhesive after activation thereof.

Some preferred but non-limiting aspects of this article comprise the following features, taken individually or in any combinations that a person skilled in the art will understand to be technically compatible with each other:
the protective layer is coated with an adhesive chosen to provide the controlled adhesive forces.
the contour of the protective layer differs from the contour of the assembly formed by the layer of paint and the layer of activatable adhesive by the presence of at least one externally protruding gripping tab.
the contour of the protective film protrudes on all sides with respect to the contour of the assembly formed by the layer of paint and the layer of activatable adhesive.
the gripping tab or tabs are inscribed within the contour of the protective film.

According to a second aspect, a method for manufacturing an article for repairing painted surfaces is proposed, comprising the following steps:
applying at least one layer of painting material on a temporary molding support,
allowing the or each layer of painting material to dry,
applying to the intermediate article a protective layer for the layer of paint,
separating from the temporary support an intermediate article formed of the layer of paint and the protective layer,
applying a layer of an activatable adhesive provided with a protective film against the exposed face of the layer of paint, the protective film being located on the side of the layer of adhesive opposite to the layer of paint, wherein the adhesive forces between the protective layer and the layer of dry paint are controlled and maintained between the adhesive forces between the protective film and the layer of adhesive before activation thereof, and the adhesive forces between the layer of paint and a final support, via the layer of adhesive after activation thereof.

According to a third aspect, a method for manufacturing an article for repairing painted surfaces is proposed, comprising the following steps:
applying at least one layer of painting material on a temporary molding support,
allowing the or each layer of painting material to dry,
applying a layer of an activatable adhesive provided with a protective film against the exposed face of the layer of paint, the protective film being located on the side of the layer of adhesive opposite to the layer of paint,
separating from the temporary support an intermediate article formed of the layer of paint, the layer of adhesive and the protective film, and
applying to the intermediate article a protective layer for the layer of paint,
   wherein the adhesive forces between the protective layer and the layer of dry paint are controlled and maintained between the adhesive forces between the protective film and the layer of adhesive before activation thereof, and the adhesive forces between the layer of paint and a final support, via the layer of adhesive after activation thereof.

Some preferred but non-limiting aspects of this method comprise the following features, taken individually or in any combinations that a person skilled in the art will understand to be technically compatible with each other:
the temporary molding support has aerodynamic performance indents/embossing transferred to the layer of paint upon application.
the protective layer has a marking on its outer face indicating the orientation of the indents/embossing.
the first protective layer is coated with an adhesive chosen to provide the controlled adhesive forces.
the contour of the first protective layer differs from the contour of the assembly formed by the layer of paint and the layer of activatable adhesive by the presence of at least one externally protruding gripping tab.
the contour of the protective film protrudes on all sides with respect to the contour of the assembly formed by the layer of paint and the layer of activatable adhesive.
the gripping tab or tabs are inscribed within the contour of the protective film.

### BRIEF DESCRIPTION OF THE DRAWINGS

Other aspects, aims and advantages of the present invention will appear better upon reading the following detailed description of preferred embodiments thereof, given by way of non-limiting example and made with reference to the appended drawings, wherein:

FIGS. 1A to 1E are enlarged sectional views illustrating different steps of manufacturing an article according to a first embodiment of the invention,

FIG. 2 is a sectional view, enlarged in the direction of thickness, of an article according to an embodiment of the invention,

FIG. 3 is a plan view from below of the article of FIG. 2,

FIG. 4 is a sectional view of the article after application, and

FIGS. 5A to 5E are enlarged sectional views illustrating different steps of manufacturing an article according to a second embodiment of the invention,

### DETAILED DESCRIPTION OF PREFERRED EMBODIMENTS

We will now describe an article allowing, in particular, the repair of damage to paint applied to a structure, in particular an aircraft, while avoiding having to resort again to all the steps necessary for the application of the paint in liquid form, thus obtaining a time saving and meeting without difficulty the regulatory health, safety and environment (HSE) criteria, while obtaining a repair of very good durability.

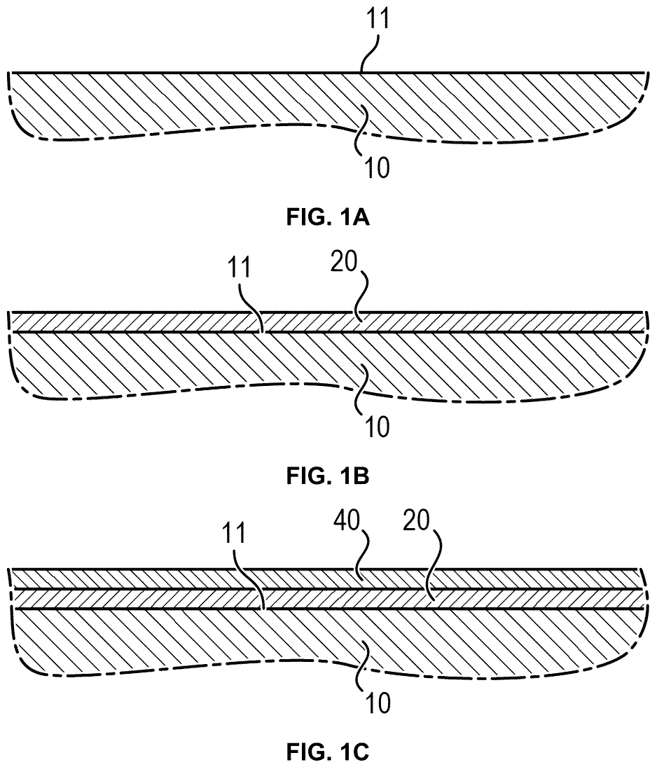

With reference to the drawings, and first of all to FIGS. 1A to 1E, it is first provided (FIG. 1A) a temporary molding support 10, the condition of the molding surface 11 of which is suitable for determining, by molding effect, the surface condition of a layer of paint. In this embodiment, this surface is generally smooth, or has a surface condition adapted to the adhesiveness of a layer of adhesive as will be described hereinafter.

This molded support is made, for example, of one of the following materials: polypropylene, polyethylene, polyethylene terephthalate, silicone paper.

In the step of FIG. 1B, one or more layers of paint 20 are applied to the face 11 of the molding support.

If necessary, an agent for modifying the surface activity of the face 11 of the molding support 10, such as a surfactant, is applied thereon before applying the paint 20 in order to limit coalescence and to make it possible to obtain a film of homogeneous thickness.

The paint may be of the monocomponent or bicomponent type, for example of the polyurethane, epoxy, acrylic or polyester type. Depending on the desired application, one or more layers of appropriate thickness are applied.

In general, the total thickness of the layer(s) of paint 20 is chosen according to the type of paint and the application type. For an application in aviation repair, the thickness chosen is as thin as possible, in line with any regulatory requirements, for reasons of minimizing weight. It may depend on the repair area in question. For other applications, criteria of mechanical resistance to impact, erosion, UV barrier, chemical resistance to certain aggressive agents, etc. may be upheld.

“Paint” also means gel-coats, clear varnishes, a layer of varnish being then applied first to the temporary support 10, to become the outer layer as will be understood hereinafter.

In the case of an article qualified as repair for a certain application, a paint itself qualified for this application is used, available from various manufacturers. For example, for an aviation application, a paint compliant with the AMS 3095A standard is used, while for marine or industrial applications, an ACQPA-certified paint is advantageously used.

A property that can be important for applications is resistance to aggressive agents such as Skydrol®.

As stated, the thickness of the layer 20 depends in particular on the type of paint and the application in question. It may result from a compromise between a degree of protection to be provided (e.g. UV barrier) and weight constraints, particularly in aeronautics.

As a general rule, the total thickness of the layer 20 is in the order of 25 to 100 μm, preferably about 40 to 70 μm for an aviation repair application on non-exposed parts.

For certain applications, in particular for the repair of anti-erosion coatings on certain parts of aircraft (leading edges of the wings, radome in particular), the thickness of the layer of paint can reach 600 μm. In industrial or marine applications, intermediate thicknesses can be used.

Referring now to FIG. 1C, a protective film 40 is applied to the intermediate article consisting of the intermediate support 10 and the layer of paint 20, once dried, on the side of the latter, in order to protect the layer of paint during application of the article as will be described hereinafter.

This protective film 40 preferably consists of:
either the combination of a transfer film (“application tape” in English) for example made of polypropylene and a layer of adhesive, such as an acrylic adhesive or an elastomer/resin mixture, typically having a total thickness between 25 and 100 μm,
or a peelable varnish which is applied for example by coating on the layer of paint and which, after drying, forms a flexible, non-breakable and cohesive protective film; this varnish may be based on polyvinyl acetate or polyester for example, and have a thickness after drying between 100 and 300 μm.

The adhesive properties of the protective film 40 on the layer of paint 20 after application are determined such that the adhesive forces between the film 40 and the layer of paint 20 are greater than the adhesive forces between said layer of paint 20 and the temporary support 10. In this way, it becomes possible to separate the assembly formed of the layer of paint 20 and the protective film 40 from the temporary support 10 by exerting traction on the protective film, as illustrated in FIG. 1D. Thus, an intermediate article consisting of the layer of paint 20 and the protective film 40 is obtained.

Referring to FIG. 1E, the next step consists of applying a layer of adhesive 30 to the face of the layer of paint 20 opposite the protective film 40. The adhesive is advantageously selected from a group comprising pressure-sensitive adhesives (PSA), structural liquid adhesives in particular of the acrylic, polyurethane, cyanoacrylate, vinyl acetate, epoxy, phenolic, cyanoacrylate, anaerobic (for example UV-cured), or hotmelt type.

The application of the adhesive depends on the nature of the adhesive. In the case of a film adhesive, it is simply laminated with the assembly formed by the protective film of the layer of paint 20, on the side of the layer of paint. It should be noted that the layer of adhesive 30 at this stage can be secured to a protective film 31 (“liner” in English terminology) which is intended to support and/or protect it.

If applicable, the protective film 31 that accompanied the adhesive 30 during its application may be removed and replaced by another protective film 31′ of larger dimensions than the final size of the assembly formed by the layer of paint 20 and the layer of adhesive 30, as will be seen in detail hereinafter. The film 31 or 31′ is advantageously a paper coated with polyethylene, polypropylene or polyester, coated with a silicone-type release agent, with a thickness of the order of 50 to 150 μm.

The adhesive is preferably a pressure-sensitive adhesive (PSA), chosen according to the constraints of the application in question (in particular resistance to the various aggressive phenomena: temperature differences, UV radiation, chemical aggression by products such as Skydrol® in the aviation industry or other aggressive agents in other industries), and to give adhesion properties adapted to the application (pull-off or shear resistance).

The thickness of the layer of adhesive is typically between 25 and 250 μm.

A successfully tested product is an acrylic type adhesive transfer tape with a thickness of around 50 μm.

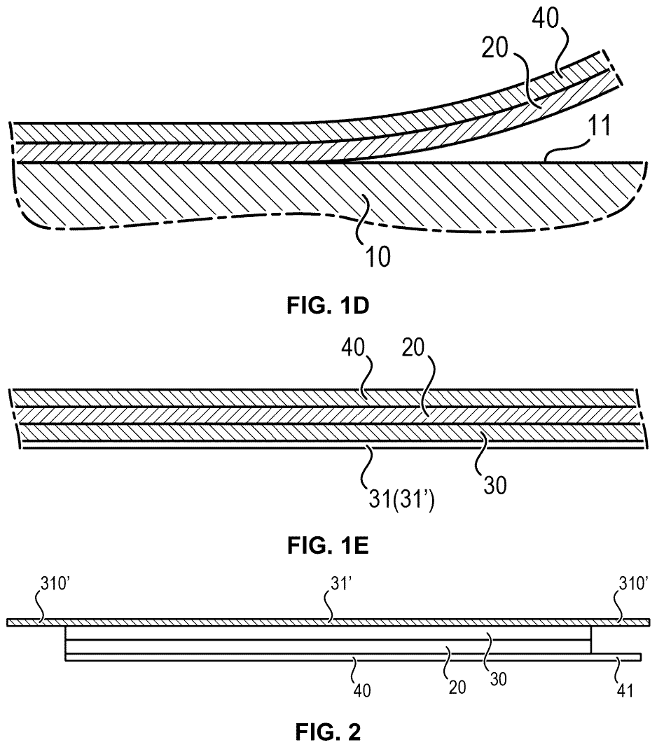

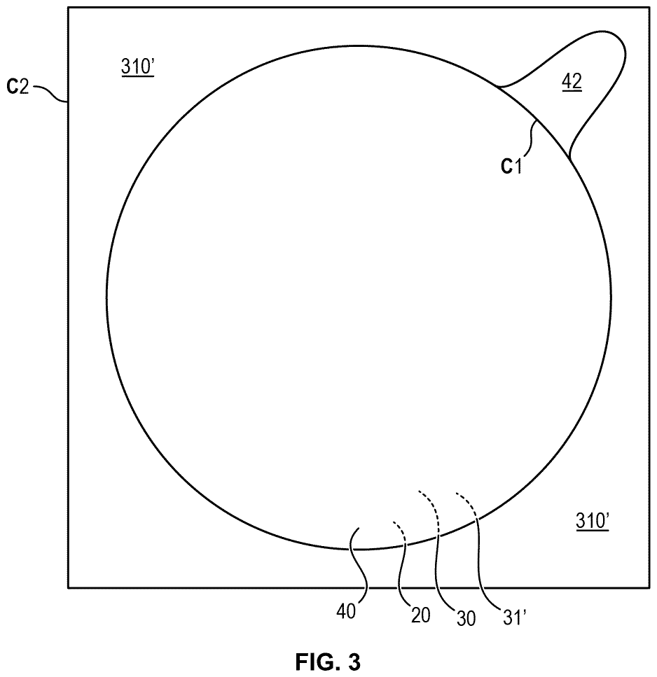

The final article is illustrated in FIGS. 2 and 3.

The assembly formed by the layers of paint 20 and adhesive 30 is here generally circular in shape, with a diameter typically between 1 and 100 cm, the contour of this assembly being designated by C1. All other shapes can of course be considered.

The protective film 31′ of the adhesive 30 here has larger dimensions than those of the assembly 20, 30, so as to have a contour C2, here of square shape, which extends beyond the contour C1 on all sides, for purposes explained hereinafter, forming a marginal zone 310′.

Finally, the protective film 40 for the application has a contour generally identical to the contour C1, with the notable presence of a gripping tab 42 (or two or more tabs) protruding outwardly with respect to this contour, for purposes explained hereinafter.

The application of the article will now be described.

Firstly, the protective film 31′ is grasped at any of the regions of its marginal zone 310′, to progressively expose the layer of adhesive on the side of the final support, consisting of an area to be repaired, previously cleaned and prepared, here an area to be repaired of an aircraft. This removal of the film 31′ is carried out gradually as the article is applied against the area to be repaired, avoiding trapping air bubbles. For this purpose, the mechanical properties of the film 31 are chosen to allow its flexion over 180° with a limited radius of curvature without inducing a risk of breakage.

This type of procedure is suitable for certain PSA or hotmelt-PSA adhesives, allowing significant flexion without loss of cohesion. With other types of adhesive such as a structural adhesive, it may be preferable to first remove the entire protective film 31′ and then apply the article to the surface to be repaired, implementing any suitable method for removing bubbles.

The fact that the film 31′ protrudes on all sides with respect to the contour C1 facilitates its removal regardless of the orientation of the article at the time of application.

Once the article has been applied and the protective film 31′ has been completely removed, a masking-type tool is applied with appropriate pressure on the exposed surface of the protective film 40 to smooth the article and activate the adhesive 30 so as to achieve a final bonding between the article and the area to be repaired. It will be noted here that the presence of the thin layer of adhesive between the film 40 and the layer of paint 20 makes it possible to avoid a relative slippage between these two elements during this operation. This risk of slipping, or damage to the film 40 or, even more disadvantageously, the layer of paint, can further be minimized by having minimal friction forces between the outer surface of the film 40 and the tool, thanks to the materials chosen for these elements.

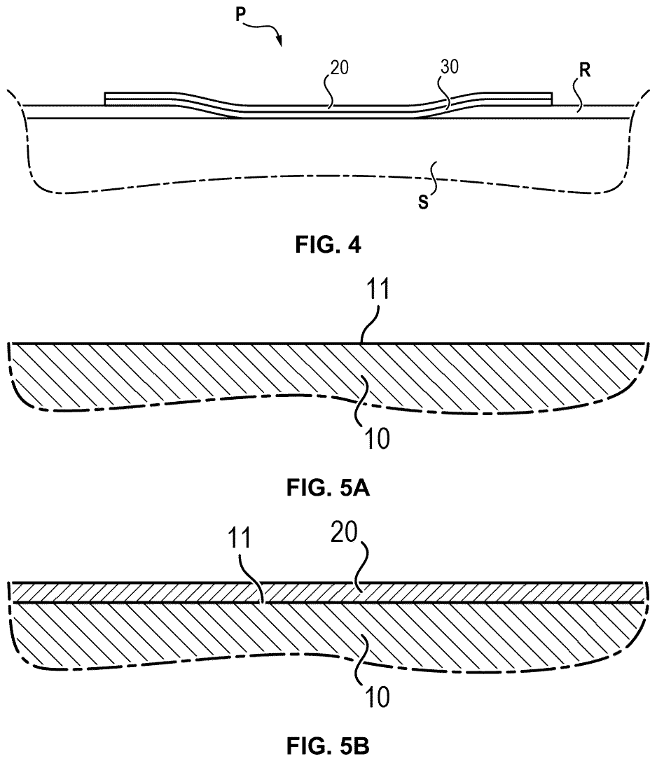

After this activation, the adhesive forces between the treated area (or final support) and the article are greater than the adhesive forces between the layer of paint 20 and the protective film 40, given by the adhesive 41. Thus, by exerting gradual traction at the tab 42, the protective film 40 can be removed without risking detaching the article from its final support. The resulting assembly is illustrated in FIG. 4, with exaggerated thickness.

In practice, the thicknesses of the layers 30 and 20 are such that the transition between the edges of the article and the rest of the substrate S (aircraft part) is barely visible, and the physical and chemical resistance of the article is comparable to that of the adjacent parts of the substrate S.

It should be noted that on an industrial level, it may be advantageous to provide the articles as described above in the form of a larger element in which a plurality of articles are obtained by cutting.

In this case, the manufacturing method described above comprises producing a set of individual intermediate articles on a strip constituting the molding support 10, and transferring, by calendering, the intermediate articles onto the protective film 40 then constituting, for the handling part, a common support of the articles.

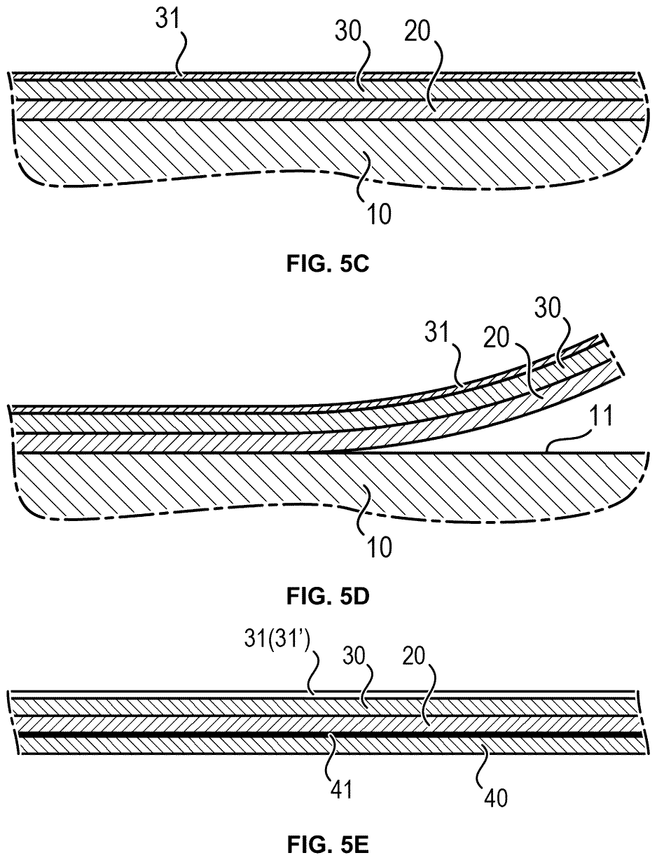

We will now describe with reference to FIGS. 5A-5E another embodiment of a method for making an article according to the invention.

First of all, we provide (FIG. 5A) a temporary molding support 10, the condition of the molding surface 11 of which is here suitable for determining, by molding effect, the surface condition of a layer of paint that will be exposed on the outside after applying the article, as will be understood hereinafter.

This molding support 10 may be structurally analogous to that of the first embodiment. It may be smooth or have any desired indented or embossed pattern, such as a material effect or micro-grooves or micro-ribs, obtained for example by calendering, to form by molding effect corresponding indents/embossing on the exposed face of the paint as will be understood hereinafter.

In the step of FIG. 5B, one or more layers of paint 20 are applied to the face 11 of the molding support.

Here again, if necessary, an agent for modifying the surface activity of the face 11 of the molding support 10, such as a surfactant, is applied thereon before applying the paint 20 in order to limit coalescence and to make it possible to obtain a film of homogeneous thickness.

The type of paint (or varnish), the number of layers and the thicknesses of the layers may be similar to that described for the first embodiment, with the adaptations necessary for the type of application. However, it should be noted that the first layer (that applied to the support 10) will be the layer exposed on the outside, and its characteristics are adapted if necessary (while in the first embodiment, it is the final layer that is exposed on the outside).

Referring to FIG. 5C, the next step consists of applying a layer of adhesive 30 to the layer of paint 20, after drying. The nature of the adhesive and the method for applying it may be of the same type as those described in the first embodiment of the method.

Here again, the choice of the adhesive 30, its thickness and the conditions of its application on the layer of paint 20 are such that the adhesive forces between the adhesive 30 and the paint are greater than the adhesive forces between the paint film 20 and the temporary support 10. In this way, it becomes possible to separate the assembly formed of the layer of paint 20 and the layer of adhesive 30, possibly provided with its film 31, from the temporary support 10 by exerting traction on the layer of adhesive 30, as illustrated in FIG. 5D. Thus, an intermediate article is obtained consisting of the layer of paint 20 and the layer of adhesive 30, possibly protected by its film 31.

As previously, if applicable, the protective film 31 that accompanied the adhesive 30 during its application may be removed and replaced by another protective film 31′ of larger dimensions than the final size of the assembly formed by the layer of paint 20 and the layer of adhesive 30, as will be seen in detail hereinafter. The film 31 or 31′ is advantageously identical or similar to that described above.

Referring now to FIG. 5E, a protective film 40 is applied to the intermediate article, on the side of the layer of paint 20, in order to protect the layer of paint during the application of the article as will be described hereinafter.

This protective film 40 is for example identical or similar to that described with reference to the first embodiment.

The final article in its general configuration is as illustrated in FIGS. 2 and 3. The contours and dimensions of the different constituents of the article may also be as described previously, and its method of application will also be similar.

As stated, the present invention finds numerous applications, and in particular repair and decoration in the aviation, aerospace, naval/maritime/offshore, land transport, industrial, construction, and renewable energy fields. Decoration here means the application of articles of forms such as decor, marking, identification, on bare (metallic, synthetic, composite, etc.) or painted surfaces.

The person skilled in the art will be able to make numerous variations and modifications using their normal skills.

In particular, in an aviation application, with the implementation of the second embodiment, the layer of paint may, as stated, be provided with aerodynamic performance indents/embossing (in particular of the “riblet” type), obtained by molding effect by appropriately structuring the molding support 10.

These aerodynamic elements must have a certain orientation with respect to the air flow to which the aircraft is exposed in flight, and, in this case, a marking may be provided on the visible surface of the layer 40 indicating the orientation of these indents/embossing, such that upon application the article is applied with the orientation appropriate to the air flow that will circulate over this area during flight.

1. An article for repairing painted surfaces, comprising:
a layer of dry paint,
a layer of an activatable adhesive adjacent to the layer of dry paint,
a protective layer adhering to the layer of dry paint on a side thereof opposite the layer of adhesive, and
a protective film attached to the layer of adhesive on the side thereof opposite the layer of dry paint,
wherein adhesive forces between the protective layer and the layer of dry paint are controlled and maintained between the adhesive forces between the protective film and the layer of adhesive before activation thereof, and the adhesive forces between the layer of paint and a final support, via the layer of adhesive after activation thereof.

2. The article according to claim 1, wherein the protective layer is coated with an adhesive chosen to provide the controlled adhesive forces.

3. The article according to claim 1, wherein a contour of the protective layer differs from a contour of the an assembly formed by the layer of paint and the layer of activatable adhesive by the presence of at least one externally protruding gripping tab.

4. The article according to claim 1, wherein a contour of the protective film protrudes on all sides with respect to a contour of an assembly formed by the layer of paint and the layer of activatable adhesive.

5. The article according to claim 3, wherein a contour of the protective film protrudes on all sides with respect to the contour of the assembly formed by the layer of paint and the layer of activatable adhesive and the gripping tab is inscribed within the contour of the protective film.

6. A method of manufacturing an article for repairing painted surfaces, comprising the following steps:
applying at least one layer of painting material on a temporary molding support,
allowing the layer of painting material to dry,
applying to an assembly made of the temporary molding support and the layer of paint a protective layer for the layer of paint,
separating from the temporary molding support an intermediate article formed of the layer of paint and the protective layer, and
applying a layer of an activatable adhesive provided with a protective film against an exposed face of the layer of paint, the protective film being located on the side of the layer of adhesive opposite to the layer of paint,
wherein adhesive forces between the protective layer and the layer of dry paint are controlled and maintained between the adhesive forces between the protective film and the layer of adhesive before activation thereof, and the adhesive forces between the layer of paint and a final support, via the layer of adhesive after activation thereof.

7. A method of manufacturing an article for repairing painted surfaces, comprising the following steps:
applying at least one layer of painting material on a temporary molding support
allowing the layer of painting material to dry,
applying a layer of an activatable adhesive provided with a protective film against an exposed face of the layer of paint, the protective film being located on a side of the layer of adhesive opposite to the layer of paint,
separating from the temporary molding support an intermediate article formed of the layer of paint, the layer of adhesive and the protective film, and
applying to the intermediate article a protective layer for the layer of paint, wherein adhesive forces between the protective layer and the layer of dry paint are controlled and maintained between the adhesive forces between the protective film and the layer of adhesive before activation thereof, and the adhesive forces between the layer of paint and a final support, via the layer of adhesive after activation thereof.

8. The method according to claim 7, wherein the temporary molding support has aerodynamic performance indents/embossing transferred to the layer of paint upon application.

9. The method according to claim 8, wherein the protective layer has a marking on its outer face indicating an orientation of the indents/embossing.

10. The method according to claim 7, wherein the protective layer is coated with an adhesive chosen to provide the controlled adhesive forces.

11. The method according to claim 7, wherein a contour of the protective layer differs from a contour of an assembly formed by the layer of paint and the layer of activatable adhesive by the presence of at least one externally protruding gripping tab.

12. The method according to claim 7, wherein a contour of the protective film protrudes on all sides with respect to a contour of an assembly formed by the layer of paint and the layer of activatable adhesive.

13. The method according to claim 11, wherein a contour of the protective film protrudes on all sides with respect to the contour of the assembly formed by the layer of paint and the layer of activatable adhesive and the gripping tab is inscribed within the contour of the protective film.
